(19) United States
(12) Patent Application Publication
(10) Pub. No.: US 2025/0335180 A1
(43) Pub. Date: Oct. 30, 2025

(54) System and method for automated review and implementation of code changes in an application

(71) Applicant: Bank of America Corporation, Charlotte, NC (US)

(72) Inventors: Ayyappan Thirukkannan, Robbinsville, NJ (US); Geetha Dwarakapuram, Newtown, PA (US); Yogi Ahuja, Warwick, PA (US); Suchetha S. Konanur, Princeton, NJ (US); Vishma Ghimiray, North Brunswick, NJ (US); Dexter Curtis Taylor, Frisco, TX (US); Karthikeyan Murugan Dever, Cranbury, NJ (US); Hardik Shaunkani, Ahmedabad (IN)

(21) Appl. No.: 18/649,232

(22) Filed: Apr. 29, 2024

(51) Int. Cl. G06F 8/70

(52) U.S. Cl. CPC G06F 8/70

(57) ABSTRACT

A system for implementing code changes comprises a code repository that stores replacement lines of code that each have a relevancy ranking and a safety ranking. The system is configured to receive a notice from an external source hosting an application that a previous set of code associated with the application needs to be changed. The system then identifies a new set of codes from the code repository with high relevance and safety values. It implements a virtual secured environment that simulates the application with the identified new set of code and one or more other external source components. Feedback is then received from the virtual secured environment and recorded in a log. The new set of code is then sent to the external source for implementation when the feedback does not indicate a failure.

### TECHNICAL FIELD

The present disclosure relates generally to code development and, more specifically, to a system and method for automated review and implementation of code changes in an application.

### BACKGROUND

Large organizations often utilize complex computing systems, such as data centers, to carry out day-to-day operations. In these systems, many applications and computing devices may be connected by local connections and/or broader networks such as the Internet. The applications are increasingly interdependent upon each other and the computing devices hosting them. Changes to an application, such as an update, may lead to unexpected changes to a seemingly unrelated application or computing device. Therefore, consideration of unintended consequences is needed when making changes to applications and/or the computing devices hosting them. The existing approaches to mitigate unintended consequences are inefficient and unreliable for complex systems and applications.

### SUMMARY

The system and method disclosed in the present application provide a technical solution to the technical problems discussed above by providing the capability to automatically select replacement lines of code from a code repository and test the replacement lines of code in a simulated environment. By automatically selecting and testing replacement lines of code, unintended consequences may be avoided, and the replacement lines of code may also better meet organizational and/or regulatory requirements. Once the lines of code are tested and found not to have unintended consequences, they may be automatically deployed to the production, active, and/or live system. When, instead, the lines of code are found to cause failures or problems, different lines of code may be selected from the code repository and tested. The best code may be identified and implemented in the production system.

In one embodiment, the disclosed system implements code changes. The system includes a memory configured to store a code repository that holds one or more sets of replacement lines of code, each having a relevancy and safety ranking. The system also includes an operable processor coupled to the memory. The processor is configured to receive a notice from an external source that hosts an application that a previous set of code associated with the application needs to be changed. After receiving the notice, the processor identifies a new set of code from the code repository, based at least in part upon the new code set with a high relevance and safety ranking. The processor then implements a virtual secured environment that comprises a simulation of the application and one or more other components of the external source that hosts the application. The simulation uses the identified new set of code and produces feedback.

The processor then receives feedback from the virtual secure environment. The feedback includes an indication of whether the identified new set of code causes a failure. The identified new set of code is indicated to cause a failure when a determination is made that the identified new set of code causes a security vulnerability or loss of function of one or more components of the simulation. The feedback is recorded in a log, and the new set of code is sent to the external source for implementation when the feedback does not indicate a failure. When the feedback indicates a failure, an additional new code set is selected. The application is then simulated in the virtual secured environment with the identified additional set of code. Additional feedback is received from the virtual secured environment and recorded in the log. When the additional new set of code does not indicate a failure, the external source implements the additional new set of code.

The disclosed system provides several practical applications, such as efficient code testing before deploying it in a live production system or environment. The disclosed system also allows for automatically selecting new code from a code repository to replace problematic code in the live production system when the live and/or production system encounters attacks, failures, or other problems. These actions may be taken before a user or operator is even aware that a problem or attack has occurred. Accordingly, the disclosed system alleviates technical problems associated with running substandard code in a live production system or environment, such as downstream system failures, errors, and downtime of other computer or network equipment. It also reduces the need to change code multiple times, which may lead to computer or network equipment downtime. These technical advantages improve the underlying computer and network systems.

By automatically selecting and testing the code, the disclosed system allows changes to code much more rapidly than prior methods. Further, automatic testing may avoid situations in large systems and/or organizations where connections between one part of the system or organization and the part being changed are not adequately understood. This will give users better performance, ensure that applications function as intended, and have less or no downtime.

Certain embodiments of the present disclosure may include some, all, or none of these advantages. These advantages and other features will be more clearly understood from the following drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system configured for implementing code changes in an application; and

FIG. 2 illustrates one embodiment of a flowchart for automatically implementing code changes in an application.

### DETAILED DESCRIPTION

### System for Automated Review and Implementation of Code Changes in an Application, Overview

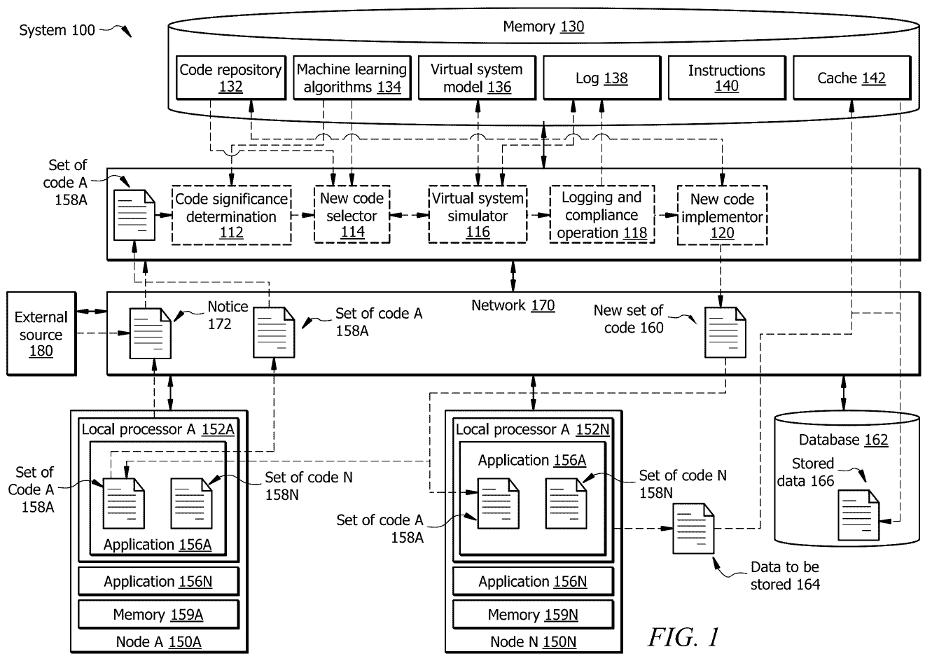

FIG. 1 is a schematic diagram of a system 100 configured to review and implement code changes in an application, e.g., 156A. More specifically, system 100 is configured to determine a new set of code 160 from a code repository 132 to implement when a notice 172 is received that a previous set of code, e.g., 158A, needs to be changed. Processor 110 receives the notice 172 from a computational device connected to network 170, such as, but not limited to, two or more nodes, 150A-150N and/or another external source 180 that hosts an application 156A or monitors the nodes 150A-150N. Once the processor 110 receives the notice 172, it retrieves the appropriate set of code, e.g., 158A, and performs a code significance determination operation 112, a new code selector operation 114, a virtual system simulator operation 116, a logging and compliance operation 118 and a new code implementor operation 120 to generate the new set of code 160 which replaces the previous set of code, e.g., 158A in two or more of the nodes 150A-150N.

In one embodiment, system 100 comprises a processor 110 and a memory 130 in signal communication through a network 170 with one or more nodes 150A-150N and optionally a database 162. The system 100 may be configured as shown or in any other suitable configuration.

### Nodes

The nodes 150A-150N may be any number of devices that perform applications 156A-156N. Examples of nodes 150A-150N include but are not limited to, computers, laptops, mobile devices (e.g., smartphones or tablets), servers, clients, automated teller machines (ATM), point of sale devices (POS), or any other suitable type of devices that may be used for accessing or supporting an application 156A-156N. The nodes 150A-150N each includes at least one local processor 152A-152N that performs one or more processes or operations, including sending a set of code, e.g., 158A to the processor 110 through the network 170 for implementing code changes in the application 156A by replacing the set of code, e.g., 158A with a new set of code 160 received from the processor 110 through the network 170.

The nodes 150A-150N may include at least one local memory 159A-159N for storing instructions for performing one or more applications 156A-156N as well as communicating a set of code 158A through the network 170 to the processor 110 and implementing a new set of code 160 received from the processor 110 through the network 170. The local memory 159A-159N may store other data and instructions related to the operations of the nodes 150A-150N and is not limited to the above-described instructions and data.

While FIG. 1 shows the nodes 150A-150N each including a single local processor 152A-152N and a single local memory 159A-159N, they may include any suitable number and combination of local processors 152A-152N and local memories 159A-159N as well as any other necessary components; with only one local processor, e.g., 152A and one local memory, e.g., 159A being shown in FIG. 1 for simplicity.

The nodes 150A-150N are configured to perform or host one or more applications 156A-156N. The one or more applications 156A-156N may include but are not limited to, applications 156A-15N that exchange data with other nodes 150N, external sources 180, and/or database 162. The one or more applications 156A-156N may include web pages, database applications, banking applications, word processing applications, entertainment applications, video applications, and/or any other applications that an organization may have hosted by one or more nodes 150A-150N.

In general, the applications 156A-156N comprise multiple lines of code. These lines of code may be organized as multiple sets of code 158A-158N. Each set of code 158A-158N may in one or more embodiments be replaced by a new set of code 160 when it is determined that a set of code, e.g., 158A, is no longer functioning as intended or is causing problems with other components of the system 100 or even outside of the system 100. A set of code, e.g., 158A, may also or, in addition, be replaced by a new set of code 160 when a security flaw or security vulnerability or loss of function is discovered in the lines of code making up the set of code, e.g., 158A. A set of code, e.g., 158A, may need to be modified or replaced with a new set of code 160 for various reasons, and the disclosure is not limited to the abovementioned reasons.

In one or more embodiments, the nodes 150A-150N may serve as an external source 180 of a notice 172. Alternatively, the external source 180 may be a separate computational device. The nodes 150A-150N, acting as the external source 180 and/or a different external source 180, may produce a notice 172 that is sent through the network 170 to the processor 110 to indicate that at least one set of code, e.g., 158A needs modified or replaced to make a new set of code 160.

### Database

In one or more embodiments, the applications 156A-156N may have data 164 stored in a database 162, and/or the applications 156A-156N may need to retrieve stored data 166 from a database 162. The database 162 may receive data to be stored 164 directly from the nodes 150A-150N or through the network 170 from the processor 110, which may, in one or more embodiments, use a cache 142 in memory 130 to store the data to be stored 164 until it is ready to be stored in the database 162 as stored data 166.

In one or more embodiments, the data to be stored 164 may need to be stored in a cache 142 in the memory 130 before being written in the database as stored data 166 for various reasons. In one example, when notice 172 is received by processor 110 from an external source 180 and/or the nodes 150A-150N, it may be determined that the data to be stored 164 should be temporarily stored in memory 130 as part of cache 142. This may occur when, for example, a determination that the current set of code, e.g., 158A, may have a security vulnerability, loss, or flaw or may be producing incorrect or flawed data 164. By storing the data to be stored 164 in the cache instead of directly in database 162, the previous set of code, e.g., 158A, may be replaced with a new set of code 160, eliminating any problems. Further, a different application, e.g., 156N, may be used in one or more embodiments to scan or ensure that the data to be stored 164 in cache 142 has no flaws or should be stored. This may prevent inaccurate, flawed, and/or potentially corrupt data from being stored in the stored data 166.

The data may be stored using SQL or other query languages in one or more embodiments. The database 162 may be part of memory 130, one or more of the nodes 150A-150N, or other components of system 100. Alternatively, or additionally, the database 162 may be located on cloud storage connected to processor 110 and nodes 150A-150N through network 170. The stored data 166 may be stored in any form, and the database 162 may take any form without departing from the disclosure.

### Network

The network 170 may be any suitable type of wireless and/or wired network including, but not limited to, all or a portion of the Internet, an intranet, a private network, a public network, a peer-to-peer network, the public switched telephone network, a cellular network, a local area network (LAN), a metropolitan area network (MAN), a wide area network (WAN), and a satellite network. The network 170 may be configured to support any suitable type of communication protocol as would be appreciated by one of ordinary skill in the art.

The network 170 may connect the nodes 150A-150N, with the processor 110 and memory 130 as part of a local network 170. Alternatively, network 170 may connect one or more of the nodes 150A-150N and/or the processor 110 and memory 130 to and/or through the Internet or other large networks to each other and other components of system 100. In one or more embodiments, different elements of system 100 may be at different geographic locations and connected through network 170. While shown as a single network 170, the network 170 may comprise a plurality of components of any suitable networking equipment, including but not limited to routers and switches, that allow at least the nodes 150A-150N to communicate with the processor 110, database 162, and/or memory 130. Network 170 is not limited to the configuration shown in FIG. 1, which is simply shown in this form for simplicity and explanatory purposes.

### Memory

Memory 130 may be any type of storage for storing a computer program comprising instructions 140, code repositories 132, machine learning algorithms 134, virtual system models 136, logs 138, and at least one cache 142. The memory 130 may be a non-transitory computer-readable medium in operative communication with the processor 110. The memory 130 may be one or more disks, tape drives, or solid-state drives. Alternatively, or in addition, the memory 130 may be one or more cloud storage devices. The memory 130 may also be used as an over-flow data storage device to store applications, e.g., 156A-156N, when such applications, e.g., 156A-156N, are selected for execution and to store instructions 140 and data that are read during the execution of the applications. The memory 130 may be volatile or non-volatile. It may comprise read-only memory (ROM), random-access memory (RAM), ternary content-addressable memory (TCAM), dynamic random-access memory (DRAM), and static random-access memory (SRAM).

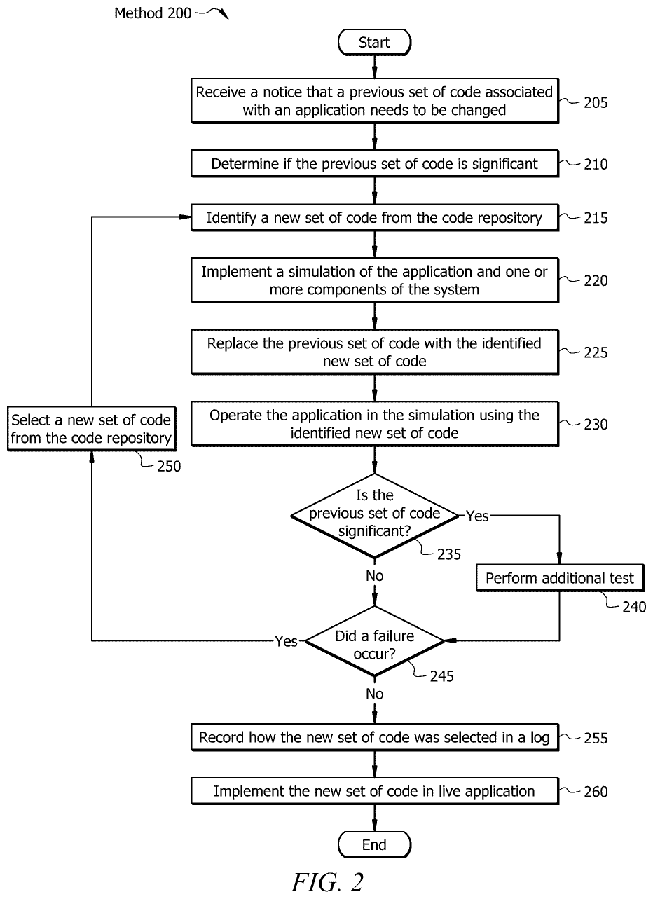

The memory 130 stores instructions 140 that, when executed by the processor 110, causes the processor 110 to perform the operations described in FIGS. 1 and 2 below. Instructions 140 may comprise any suitable set of instructions, logic, rules, or code. The memory 130 may include storage that may take the form of a database for storing such things as code repository 132, machine learning algorithms 134, virtual system model 136, logs 138, and cache 142. These may be stored and recalled using known protocols such as SQL, XML, and/or any other protocol or language that a user, administrator, or developer of the system 100 wishes to use. The code repository 132, machine learning algorithms 134, virtual system model 136, logs 138, and cache 142 may be stored in other forms, and the disclosure is not limited to storing code repository 132, machine learning algorithms 134, virtual system model 136, logs 138, and cache 142 as a database.

The memory 130 in one or more embodiments stores a code repository 132. The code repository 132 stores various sets of code that may be used as a new set of code 160 to replace one or more sets of code, e.g., 158A. Each set of code stored in the code repository 132 of memory 130 may be associated with a relevancy ranking and a safety ranking.

The relevancy ranking may indicate whether the lines of code are relevant to a particular application, e.g., 156A, or a particular problem; for example, in a non-limiting example, a new set of code, 160 may have a high ranking for security or a high ranking for managing a large volume of data. The relevancy ranking may be assigned based on previous deployments of the lines or set of code to solve similar problems in similar applications, e.g., 156N, or in the same application, e.g., 156A. The set of code, e.g., 158A, may be stored in the code repository 132 of the memory 130 with metadata or other kinds of data that indicate how it was used before or what it may be used. Alternatively, or in addition, it may include comments or other information on how it may or has been used. The relevancy ranking may be determined by the processor 110, a user, or an administrator. Alternatively, the relevance ranking may be determined by one or more machine learning algorithms 134 used by the processor 110 to determine the relevancy rankings. The relevancy ranking is not limited to the above examples and may be determined based on any criteria and by any relevant entity.

Similarly, the safety ranking may be stored in the memory 130. The safety ranking may indicate how the set of code, e.g., 158A, has performed in other applications, e.g., 156N, or the same application, e.g., 156A. The safety ranking may be assigned based on previous deployments of the lines or set of code to solve similar problems in similar applications, e.g., 156N, determined from data stored in log 138 or data stored along with the sets of code, e.g., 158A. The user or administrator may choose the safety ranking. Alternatively, one or more machine learning algorithms 134 may determine the safety ranking. The safety ranking may indicate that in the previous application of a new set of code 160, there was limited impact on other components of system 100. The safety ranking may also be updated when the virtual system simulator operation 116 is performed by the processor 110. For example, if the virtual system simulator operation 116 found that the new set of code 160 caused more than one component of system 100 to fail, the new set of code 160 would be given a lower safety ranking when stored in the code repository 132 of the memory 130. The safety ranking is not limited to the above examples and may be determined based on any criteria and by any appropriate entity.

The memory 130 in one or more embodiments stores machine learning algorithms 134. The machine learning algorithms 134 may include any useful machine learning algorithms 134, such as, but not limited to, neural networks such as a convolutional neural network (CNN) and long short-term memory (LSTM) neural networks. In at least one embodiment, the machine learning algorithm 134 may be used by the processor 110 when performing a code significance determination operation 112 and new code selector operation 114, as well as any other operation or application performed by processor 110. The memory 130 may store additional or other machine learning algorithms 134, and the machine learning algorithms 134 are not limited to those just described.

The memory 130 in one or more embodiments stores a virtual system model 136. The virtual system model 136 may include an image or simulation of one or more applications 156A-156N, database 162, and devices such as the nodes 150A-150N that comprise system 100 or connected devices (not shown). The virtual system model 136 may be a virtual secured environment that is separated from the rest of system 100 and/or has other means, such as air gapping, to keep any errors caused by the new set of code 160 causing a failure of system 100. The virtual system model 136 may include sufficient details that the processor 110 performing the virtual system simulator operation 116 may make an adequate analysis of how a new set of code 160 may have if implemented in an application, e.g., 156A. In one or more embodiments, the virtual system model 136 may be a sandboxed model of the system 100 or one or more of the nodes 150A-150N. While only one virtual system model 136 is shown, multiple virtual system model 136 may be stored in memory 130. The virtual system model 136 may take any form without departing from the disclosure.

The memory 130 in one or more embodiments stores a log 138. The log 138, in one or more embodiments, stores the results of the virtual system simulator operation 116 and the reasons that a new set of code 160 is being used. This information and any other helpful information are stored in the log 138 when the processor 110 performs a logging and compliance operation 118. The information is stored in log 138 to meet regulatory requirements and keep a record for audits, troubleshooting, debugging, and any other purpose where a record of the changes, results of the virtual system simulator operation, and new code implementor operation 120 are needed. When processor 110 performs operations 112-120 and/or the operation described regarding method 200 of FIG. 2, information may be stored in log 138 for future use.

### Processor

The processor 110 may take the form of any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 110 may be a programmable logic device, a microcontroller, a microprocessor, or any suitable combination of the preceding. The processor 110 is communicatively coupled to and in signal communication with the memory 130. The one or more processors making up the processor 110 are configured to process data and may be implemented in hardware or software. For example, the processor 110 may be 8-bit, 16-bit, 32-bit, 64-bit, or of any other suitable architecture. The processor 110 may include an arithmetic logic unit (ALU) for performing arithmetic and logic operations, processor registers that supply operands to the ALU and store the results of ALU operations, and a control unit that fetches instructions 140 from memory 130 and executes them by directing the coordinated operations of the ALU, registers and other components.

The processor 110 is in operative communication with the memory 130. The processor 110 is configured to implement various instructions 140 stored in memory 130. The processor 110 may be a special-purpose computer designed to implement the instructions 140 and/or functions disclosed herein. For example, the processor 110 may be configured to perform operations, including the operations of the methods described in FIG. 2.

The processor 110 uses the code repository 132, machine learning algorithms 134, virtual system model 136, and log 138 to perform various operations such as, but not limited to, a code significance determination operation 112, new code selector operation 114, virtual system simulator operation 116, logging and compliance operation 118, and new code implementor operation 120. The processor 110 may perform more or less operations than shown in FIG. 1 and described in FIG. 2; the specific operations shown are only examples. While a single processor 110 is shown, the processor 110 may include a plurality of processors or computational devices. The operations, e.g., code significance determination operation 112, new code selector operation 114, virtual system simulator operation 116, logging and compliance operation 118, and new code implementor operation 120, described herein as being performed by the processor 110 may be performed by a separate processor 110 or software application executed on a single computational device e.g., processor 110, or they may be located on separate servers, separate datacenters such as a cloud server, and/or one or more of the nodes 150A-150N.

The processor 110, in one or more embodiments, receives a notice 172 that a previous set of code, e.g., 158A, associated with an application 156A, needs to be changed using network 170. The processor 110 then performs a plurality of operations to determine which of the new sets of code 160 are stored in the code repository 132 to replace the set of code, e.g., 158A in one or more nodes 150A-150N.

The processor 110 in one or more embodiments receives a notice 172 via network 170 that a previous set of code, e.g., 158A, associated with at least one application, e.g., 156A, must be changed. This notice 172 may come from an external source 180, such as the one or more of the nodes 150A-150N that hosts at least one application, e.g., 156A, or a separate external source 180 connected to the network 170. The notice 172, alternatively or in addition, may come from any other computational devices, users, and/or administrators connected to the processor 110 through network 170. Either after processor 110 receives the notice 172 or simultaneously, the processor 110 requests and/or receives the set of code, e.g., 158A, to be modified or replaced from one or more of the nodes 150A-150N.

Once the processor 110 receives the set of code, e.g., 158A from one or more nodes 150A-150N, the processor 110 begins performing a code significance determination operation 112. The processor 110, when performing the code significance determination operation 112, analyzes the previous set of code, e.g., 158A, as well as the application 156A that the set of code, e.g., 158A, is from to determine its significance. In one or more embodiments, the code significance determination operation 112 determines the significance of the previous set of code, e.g., 158A, based at least in part upon how much the previous set of code, e.g., 158A, interacts with other code, applications, and devices. The code significance determination operation 112 may be performed by the processor 110 using one or more machine learning algorithms 134 retrieved from the memory 130.

A set of code, e.g., 158A, may have more significance when it is needed for performing a critical function, such as storing data 166 in a database 162. In contrast, code that determines the color of a screen for a user's graphical user interface (GUI) may be deemed less significant. Another example is that a set of code, e.g., 158A, that processes a user's critical information (for example, social security numbers or account numbers) would be considered highly significant, especially regarding security considerations. The processor 110, when performing the code significance determination operation 112, may determine that a set of code, e.g., 158A, is more or less significant based on any factor, and the disclosure is not limited to the above examples.

The significance of the set of code, e.g., 158A, may, in one or more embodiments, determine what other operations need to be performed. For example, in one or more embodiments, the virtual system simulator operation 116 and logging and compliance operation 118 may not need to be performed by the processor 110 when it is determined that the set of code, e.g., 158A, is not significant. Alternatively, in one or more embodiments, if the set of code, e.g., 158A, is determined by processor 110 to be highly significant in the code significance determination operation 112, additional tests may be performed on a new set of code 160 prior to sending it and/or implementing it by the nodes 150A-150N and/or external source 180, by processor 110 performing the new code implementor operation 120.

Once the significance of the code is determined in the code significant determination operation 112 by the processor 110, the processor 110 performs a new code selector operation 114. The processor 110, when performing the new code selector operation 114, retrieves one or more sets of code from code repository 132 that have high relevance rankings and safety rankings and are suitable replacements for the set of code, e.g., 158A. In one or more embodiments, the processor 110 will choose the new set of code 160 with the highest relevancy and safety rankings. However, the processor 110 may choose the new set of code 160 based on other criteria. In one or more embodiments, the processor 110, when performing the new code selector operation 114, may use one or more machine learning algorithms 134 or other forms of artificial intelligence (AI) to choose the best code along with the relevancy and safety rankings.

Once the new set of code 160 is selected by the processor 110 performing the new code selector operation 114, the processor 110 executes a virtual system simulator operation 116. In the virtual simulator operation 116, the processor 110 makes a simulation of the application 156A, any applications, e.g., 156N, that the application 156A interacts with, and any other components of the system 100 that the application 156A and/or set of code, e.g., 158A may affect. The simulation may take the form of a virtual secured environment or sandbox, which allows for simulating the production environment without causing a failure of one or more nodes 150A-150N, any external device, or the system 100 in general. The processor 110 may additionally use data from log 138 to properly simulate the system 100. The processor 110 may simulate the database 162, other processors (not shown), or components that are outside of system 100 and connected by the network 170. In one or more embodiments, the processor 110 performing the virtual system simulator operation 116 makes a sandboxed simulation of the system 100 or one or more components of the system 100.

The processor 110, performing the virtual system simulator operation 116, has the simulated application 156A and uses the new set of code 160 to perform one or more applications. The processor 110 then may determine how the new set of code 160 behaves in the simulated application 156A and simulated system 100. The processor 110 generates feedback from the virtual system simulator operation 116, including an indication that the new set of code 160 fails or causes the virtual system model 136 to fail. Any feedback generated from the virtual system simulator operation 116 may then be recorded in the memory 130 as part of one or more logs 138. When the feedback indicates that the new set of code 160 failed, the feedback is recorded in the memory 130 in the log 138. Then, the processor 110 will return to the new code selector operation 114 to select another new set of cod 160. Failure may occur when one or more applications 156A-156N or attached components, such as database 162, do not function as intended during the virtual system simulator operation 116. Failure may also occur when a flaw is noted, or the new set of code 160 causes a security vulnerability or loss of function of one or more components of the simulation. The processor 110, performing the virtual system simulator operation 116, may determine that the new set of code 160 caused a flaw for various reasons, and the disclosure is not limited to the examples just described.

As previously discussed, if processor 110 performing the virtual system simulator operation 116 determines that the new set of code 160 fails, then the processor 110 returns to the new code selector operation 114, where another new set of code 160 is selected. This may be the next highest-ranked code based on its rankings stored in the code repository 132, or it may even be to keep the original set of code, e.g., 158A. Further, if no new set of code 160 is found that passes or does not fail in the virtual system simulator operation 116, either the best performing new set of code 160 is implemented, or in one or more embodiments, a user, administrator, programmer, and/or manufacture may be notified so that appropriate intervention may be performed such as, but not limited to, providing a new set of code 160 that has not previously been stored in the code repository 132 of memory 130.

Once the processor 110, performing the virtual system simulator operation 116 determines that a new set of code 160 has not failed, the steps taken by the processor 110 to select the new set of code 160 are stored in log 138 by the processor 110 performing the logging and compliance operation 118. When performing the logging and compliance operation 118, the processor 110 may analyze the new set of code 160 and any steps the processor 110 took and make appropriate log entries. The processor 110 may also perform other steps required for regulatory purposes and/or the organization that operates system 100. This data, or a subset of the data, is stored in log 138 of the memory 130 by the processor 110.

Once appropriate logging is performed by the processor 110 performing the logging and compliance operation 118, the processor 110 then implements the new code in the new code implementor operation 120. The processor 110 sends the new set of code 160 through the network 170 to at least one node, e.g., 150A, where it is implemented. Where the code is significant, the new set of code 160 may have additional tests performed on it before implementation and/or may be implemented by the processor 110 in only one node, e.g., 150A at a time, to ensure that the entire system 100 continues to function, for example as a rolling update. Alternatively, all of the nodes 150A-150N in the system 100 may have the new set of code 160 implemented by the processor 110, performing the new code implementor operation 120 at the same time.

### Automated Review and Implementation of Code Changes Process

FIG. 2 is a flowchart of an embodiment of method 200 for implementing code changes in an application, e.g., 156A, by the processor 110. The processor 110 may execute instructions 140 stored in the memory 130, which employs method 200 for implementing code changes in an application, e.g., 156A.

The method 200 begins at operation 205, where the processor 110 receives a notice 172 that a previous set of code, e.g., 158A associated with an application 156A needs to be changed. This notice 172 may come from an external source 180 connected to the processor 110 through the network 170. Alternatively, in one or more embodiments, the notice 172 may come from a user, administrator, and/or any other concerned parties using one or more nodes 150A-150N or other devices connected through network 170 to the processor 110.

Once notice 172 is received in operation 205, the processor 110 then determines if the previous set of code, e.g., 158A, is significant in operation 210. The significance of the previous set of code, e.g., 158A, may be determined based on any predetermined criteria such as, but not limited to, how much the previous set of code, e.g., 158A, interacts with other sets of code, e.g., 158N, applications, e.g., 156N and/or devices. The significance may also be determined based on how the previous set of code, e.g., 158A, processes or manages sensitive information and financial information or is key to the operation of one or more applications 156A-156N. A user, administrator, regulator, or other concerned entity may select the predetermined criteria based on the specifics of the application 156A and/or the system 100, as well as an organization's function or purpose.

Once the significance of the previous set of code, e.g., 158A, is determined by the processor 110, the processor 110 identifies a new set of code 160 from the code repository 132 in operation 215. The new set of code 160 may be selected based on the new set of code 160 having the highest relevancy ranking and safety ranking of any set of code, e.g., new set of code 160 stored in the code repository 132 that is able to perform a similar function or the same function that the previous set of code, e.g., 158A. Alternatively, and/or in addition, the new set of code 160 may be selected by the processor 110 using AI or a machine learning algorithm 134 stored in the memory 130, which is trained to determine the best code to use to address a specific flaw or problem with the previous set of code, e.g., 158A. The specific flaw or problem with the previous set of code, e.g., 158, may be indicated in the notice 172 or may be determined by another means, such as by having the processor 110 analyze the previous set of code, e.g., 158A, one or more log entries in the log 138 stored in the memory 130, or by any other means.

Once a new set of code 160 is identified from the code repository 132, the processor 110 implements a simulation of the application 156A and one or more components of the system 100 in operation 220. The simulation may be based on a virtual system model 136 stored in memory 130 or may be crafted based on data received from one or more nodes 150A-150N and/or the log 138 stored in memory 130. The simulation in one or more embodiments may be a sandboxed version of all or part of system 100. Once the simulation is implemented by processor 110, it replaces the previous set of code, e.g., 158A, with one of the identified new sets of code 160 in operation 225, and the application 156A and/or system 100 is operated in the simulation by processor 110 in operation 230.

After operation 230 is performed, or simultaneously while the simulation is being performed by the processor 110, the processor 110 uses the determination made in operation 210 to determine if the previous set of code, e.g., 158A, is significant in operation 235. If the previous set of code, e.g., 158A, is determined to be significant in operation 235, processor 110 may perform additional tests in operation 240. These tests may be required by the organization that operates system 100 or tests needed for a regulatory or other organization for a significant set of code, e.g., 158A. The additional tests performed by the processor 110 in operation 240 may include having the new set of code 160 reviewed by one or more administrators and/or reviewed by one or more other applications 156N for reviewing the new set of code 160.

After performing the additional test in operation 240 and/or after determining that the code is not significant in operation 235, the processor 110 then determines if a failure occurred in operation 245. If the processor 110 or another entity performing the additional tests in operation 240 and/or the simulation in operation 230 determines that a failure did occur, in that case, the processor 110 then selects a new set of code 160 from the code repository in operation 250. Operations 215-250 are repeated until processor 110 determines that a failure has not occurred with a selected new set of code, e.g., 160.

Once a new set of code 160 is identified that does not have a failure during the simulation in operation 230 and/or when performing additional tests in operation 240, the processor 110 performs an optional operation 255 and records how the new set of code 160 was selected in a log 138 stored in memory 130. This log 138 is kept to comply with regulatory and organizational requirements. Additionally, the log may be maintained in case troubleshooting needs to be performed at a later time.

Once the log 138 is recorded by the processor 110 in operation 255, or if no log is needed, the processor 110 implements the new set of code 160 in the live application 156A in operation 260. This may be performed by the processor 110 communicating the new set of code 160 through the network 170 to one or more nodes 150A-150N to be implemented one node, e.g., 150A at a time, several nodes, e.g., 150A at a time, or all of the nodes 150A-150N. How the new set of code 160 is implemented in operation 260 is determined by the significance of the previous set of code, e.g., 158A, or based on the properties of the new set of code 160 and/or application 156A determined by the processor 110 and/or organization's requirements. Once operation 255 is completed, the method 200 of FIG. 2 ends.

While several embodiments have been provided in the present disclosure, it should be understood that the disclosed systems and methods might be embodied in many other specific forms without departing from the spirit or scope of the present disclosure. The present examples are to be considered illustrative and not restrictive, and the intention is not to be limited to the details given herein. For example, the various elements or components may be combined or integrated into another system, or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To aid the Patent Office and any readers of any patent issued on this application in interpreting the claims appended hereto, applicants note that they do not intend any of the appended claims to invoke 35 U.S.C. § 140(f) as it exists on the date of filing hereof unless the words “means for” or “operation for” are explicitly used in the particular claim.

1. A system for implementing code changes, comprising:
a memory configured to store a code repository, the code repository storing one or more sets of replacement lines of code, each of the one or more sets of replacement lines of code having a relevancy ranking and a safety ranking; and
a processor operably coupled to the memory and configured to:
receive a notice from an external source that a previous set of code associated with an application needs to be changed, wherein the external source hosts the application;
identify a new set of code from the code repository based at least in part upon the new set of code having a high relevance ranking and a high safety ranking, wherein the identified new set of code is from the one or more sets of replacement lines of code stored in the memory;
implement a virtual secured environment that comprises a simulation of the application and one or more other components of the external source that hosts the application, wherein in the simulation, the previous set of code is replaced with the identified new set of code;
receive feedback from the virtual secured environment, wherein the feedback includes an indication of whether the identified new set of code causes a failure, wherein the identified new set of code is indicated to cause the failure when a determination is made that the identified new set of code causes a security vulnerability or loss of function of one or more components of the simulation;
record the feedback in a log; and
send the new set of code to the external source for implementation when the feedback does not indicate a failure.

2. The system of claim 1, wherein the new set of code is identified at least in part by using a trained machine learning system.

3. The system of claim 1, wherein the processor is further configured to:
identify an additional new set of code from the code repository when the feedback indicates that a failure occurs;
replace in the virtual secured environment, the previous set of code and the new set of code with the identified additional new set of code;
operate the application in the virtual secured environment with the identified additional new set of code;
receive additional feedback from the virtual secured environment;
record the additional feedback in the log; and
send the additional new set of code to the external source for implementation when the additional feedback does not indicate a failure.

4. The system of claim 1, wherein the processor is further configured to assign the relevancy ranking and the safety ranking to each of the one or more sets of replacement lines of code based at least in part upon previous deployments of the one or more sets of replacement lines of code.

5. The system of claim 1, wherein the one or more other components of the system that hosts the application includes at least a database.

6. The system of claim 5, wherein the memory includes a cache for at least temporarily storing data to be written to the database by the application until the new set of code is implemented.

7. The system of claim 1, wherein the system further comprises two or more nodes that each host the application, and wherein sending the new set of code to the external source for implementation comprises deploying the new set of code to each of the two or more nodes that host the application.

8. The system of claim 1, wherein the processor is further configured to:
determine a significance of the previous set of code, wherein the significance is based at least in part upon how much the previous set of code interacts with other code, applications, and devices; and
perform at least one additional test of the identified new set of code prior to sending the identified new set of code to the external source for implementation when the previous set of code is determined to be significant.

9. The system of claim 8, wherein the significance of the code is determined at least in part by using a trained machine learning system.

10. A method for implementing code changes:
receiving a notice from an external source that a previous set of code associated with an application needs to be changed, wherein the external source hosts the application;
identifying a new set of code from a code repository that stores one or more sets of replacement lines of code, wherein each of the one or more sets of replacement lines of code has a relevancy ranking and a safety ranking and wherein the new set of code is identified based at least in part upon the new set of code having a high relevance ranking and a high safety ranking;
implementing a virtual secured environment that comprises a simulation of the application and one or more other components of the external source that hosts the application, wherein in the simulation, the previous set of code is replaced with the identified new set of code;
receiving feedback from the virtual secured environment, wherein the feedback includes an indication of whether the identified new set of code causes a failure, wherein the identified new set of code is indicated to cause the failure when a determination is made that the identified new set of code causes a security vulnerability or loss of function of one or more components of the simulation;
recording the feedback in a log; and
sending the new set of code to the external source for implementation when the feedback does not indicate a failure.

11. The method of claim 10, wherein the new set of code is identified at least in part by using a trained machine learning system.

12. The method of claim 10, further comprising:
identifying an additional new set of code from the code repository when the feedback indicates that a failure occurs;
replacing in the virtual secured environment, the previous set of code and the new set of code with the identified additional new set of code;
operating the application in the virtual secured environment with the identified additional new set of code;
receiving additional feedback from the virtual secured environment;
recording the additional feedback in the log; and
sending the additional new set of code to the external source for implementation when the additional feedback does not indicate a failure.

13. The method of claim 10, further comprising assigning the relevancy ranking and the safety ranking to each of the one or more sets of replacement lines of code based at least in part upon previous deployments of the one or more sets of replacement lines of code.

14. The method of claim 10, further comprising:
determining a significance of the previous set of code, wherein the significance is based at least in part upon how much the previous set of code interacts with other code, applications, and devices; and
performing at least one additional test of the identified new set of code prior to sending the identified new set of code to the external source for implementation when the previous set of code is determined to be significant.

15. The method of claim 14, wherein the significance of the code is determined at least in part by using a trained machine learning system.

16. A non-transitory computer-readable medium storing instructions that when executed by a processor cause the processor to:
receive a notice from an external source that a previous set of code associated with an application needs to be changed, wherein the external source hosts the application;
identify a new set of code from a code repository that stores one or more sets of replacement lines of code, wherein each of the one or more sets of replacement lines of code has a relevancy ranking and a safety ranking and wherein the new set of code is identified based at least in part upon the new set of code having a high relevance ranking and a high safety ranking;
implement a virtual secured environment that comprises a simulation of the application and one or more other components of the external source that hosts the application, wherein in the simulation, the previous set of code is replaced with the identified new set of code;
receive feedback from the virtual secured environment, wherein the feedback includes an indication of whether the identified new set of code causes a failure, wherein the identified new set of code is indicated to cause the failure when a determination is made that the identified new set of code causes a security vulnerability or loss of function of one or more components of the simulation;
record the feedback in a log; and
send the new set of code to the external source for implementation when the feedback does not indicate a failure.

17. The non-transitory computer-readable medium of claim 16, wherein the new set of code is identified at least in part by using a trained machine learning system.

18. The non-transitory computer-readable medium of claim 16, wherein the instructions further cause the processor to:
determine a significance of the previous set of code, wherein the significance is based at least in part upon how much the previous set of code interacts with other code, applications, and devices; and
perform at least one additional test of the identified new set of code prior to sending the identified new set of code to the external source for implementation when the previous set of code is determined to be significant.

19. The non-transitory computer-readable medium of claim 16, wherein the instructions further cause the processor to:
identify an additional new set of code from the code repository when the feedback indicates that a failure occurs;
replace in the virtual secured environment, the previous set of code and the new set of code with the identified additional new set of code;
operate the application in the virtual secured environment with the identified additional new set of code;
receive additional feedback from the virtual secured environment;
record the additional feedback in the log; and
send the additional new set of code to the external source for implementation when the additional feedback does not indicate a failure.

20. The non-transitory computer-readable medium of claim 16, wherein the instructions further cause the processor to assign the relevancy ranking and the safety ranking to each of the one or more sets of replacement lines of code based at least in part upon previous deployments of the one or more sets of replacement lines of code.
